(19) United States
(12) Patent Application Publication
(10) Pub. No.: US 2017/0067323 A1
(43) Pub. Date: Mar. 9, 2017

(54) MULTI DATA RESERVOIR HISTORY MATCHING AND UNCERTAINTY QUANTIFICATION FRAMEWORK

(71) Applicant: KING ABDULLAH UNIVERSITY OF SCIENCE AND TECHNOLOGY, Thuwal (SA)

(72) Inventors: Klemens Katterbauer, Thuwal (SA); Ibrahim Hoteit, Thuwal (SA); Shuyu Sun, Thuwal (SA)

(21) Appl. No.: 15/308,930

(22) PCT Filed: Apr. 29, 2015
(86) PCT No.: PCT/IB2015/001594

§ 371 Date: Nov. 4, 2016

Related U.S. Application Data
(60) Provisional application No. 61/989,857, filed on May 7, 2014.

(51) Int. Cl. E21B 41/00; G06F 17/13

(52) U.S. Cl. CPC E21B 41/0092; G06F 17/13; E21B 49/00

(57) ABSTRACT

A multi-data reservoir history matching and uncertainty quantification framework is provided. The framework can utilize multiple data sets such as production, seismic, electromagnetic, gravimetric and surface deformation data for improving the history matching process. The framework can consist of a geological model that is interfaced with a reservoir simulator. The reservoir simulator can interface with seismic, electromagnetic, gravimetric and surface deformation modules to predict the corresponding observations. The observations can then be incorporated into a recursive filter that subsequently updates the model state and parameters distributions, providing a general framework to quantify and eventually reduce with the data, uncertainty in the estimated reservoir state and parameters.

### CROSS-REFERENCE TO RELATED DOCUMENTS

This application makes reference to and incorporates by reference the following paper as if it were fully set forth herein expressly in its entirety:

“Multi-Data Reservoir History Matching Enhanced Reservoir Forecasts and Uncertainty Quantification” by Klemens Katterbauer, Ibrahim Hoteit, and Shuyu Sun (Appendix A, hereto) which is hereby incorporated by reference in its entirety.

This application is the National Stage of International Application No. PCT/IB2015/001594, filed 29 Apr. 2015, which claims the benefit of and priority to U.S. Provisional Application No. 61/989,857, filed on 7 May 2014, having the title “MULTI DATA RESERVIOR HISTORY MATCHING AND UNCERTAINTY QUANTIFICATION FRAMEWORK”, the contents of all of which are incorporated by reference as if fully set forth herein.

### BACKGROUND

Reservoir simulations and history matching may be used to predict oil or gas reservoir states. Spatially sparse data incorporated into the history matching algorithm may pose challenges in improving model simulations and enhancing forecasts.

### SUMMARY

Disclosed are various embodiments for a reservoir forecasting application. In one or more aspects a multi-data history matching framework is provided utilizing multiple data sets such as production, seismic, electromagnetic, gravimetric and surface deformation data for improving the history matching process. In one or more aspects the history matching process is conducted via ensemble based Bayesian data assimilation techniques. The framework can consist of a geological model that is interfaced with a reservoir simulator. The reservoir simulator can interface with seismic, electromagnetic, gravimetric and surface deformation modules to predict the corresponding observations. The observations can then be incorporated into a recursive filter, such as an Ensemble Kalman Filter, or smoother, such as the ensemble Kalman Smoother, that subsequently updates the model state and parameters distributions. This provides a general framework to quantify and eventually reduce with the data, uncertainty in the estimated reservoir state and parameters.

In an embodiment, a method is provided, comprising: initializing, in a computing device, a reservoir simulator based at least in part on a geological model; generating, in the computing device, at least two observational data sets based at least in part on a current reservoir simulator state of the reservoir simulator by querying a corresponding at least two of: a seismic survey module, an electromagnetic (EM) survey module, a gravimetric survey module, or an interferometric synthetic aperture radar (InSAR) survey module; generating, in the computing device, a forecasted reservoir simulator state by applying a history matching approach to at least the current reservoir simulator state and the at least two observational data sets; and updating, in the computing device, the current reservoir simulator state to the forecasted reservoir simulator state. The steps of generating the at least two observational data sets, generating the forecasted reservoir simulator state, and updating the current reservoir simulator state can be repeated until a termination criteria is met.

In an embodiment, a system is provided, comprising: at least one computing device comprising a processor and a memory, configured to at least: initialize a reservoir simulator based at least in part on a geological model; generate at least two observational data sets based at least in part on a current reservoir simulator state of the reservoir simulator by querying a corresponding at least two of: a seismic survey module, an electromagnetic (EM) survey module, a gravimetric survey module, or an interferometric synthetic aperture radar (InSAR) survey module; generate a forecasted reservoir simulator state by applying a history matching approach to at least the current reservoir simulator state and the at least two observational data sets; and update the current reservoir simulator state to the forecasted reservoir simulator state. The at least one computing device can be configured to repeat the generating the at least two observational data sets, the generating the forecasted reservoir simulator state, and the updating the current reservoir simulator state until a termination criteria is met.

In any one or more aspects of the method or the system, the reservoir simulator can be implemented using a MATLAB reservoir simulator toolbox. The history matching approach can comprise a Bayesian data assimilation technique. The Bayesian data assimilation technique can comprise an Ensemble Kalman Filter or a singular evolutive interpolated Kalman Filter. The at least two observational data sets can be included in a plurality of observational data sets based at least in part on each of the seismic survey module, the EM survey module, the gravimetric survey module, or the InSAR survey module, and the history matching approach can be applied to the plurality of observational data sets. The geological model can define at least one of a geological structure, a number of wells, a pressure, a saturation, a permeability, or a porosity. The seismic survey module can be configured to calculate a time lapse seismic impedance profile based at least in part on a saturation data, a porosity data and the geological model, and wherein one of the at least two observational data sets can comprise the time lapse seismic impedance profile. The EM survey module can be configured to calculate a time lapse conductivity response based at least in part on a porosity data and a salt concentration data, and wherein one of the at least two observational data sets can comprise the time lapse conductivity response. The gravimetric survey module can be configured to calculate a time lapse gravimetric response based at least in part on a porosity data, a saturation data and the geological model, and wherein one of the at least two observational data sets can comprise the time lapse gravimetric response.

Other systems, methods, features, and advantages of the present disclosure for a reservoir forecasting application, will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a flowchart illustrating one example of functionality implemented as portions of a reservoir forecasting application executed in a computing environment according to various embodiments of the present disclosure.

FIG. 2 depicts an exemplary flowchart representative of the Multi-Data history matching framework of the present disclosure.

FIG. 3 depicts a five-spot pattern with the injector well-being in the middle and the producer wells around it [47]. The imaged cross sections are displayed in red [48].

FIGS. 4A and 4B depict: A) a true permeability, and B) a porosity field for the studied reservoir.

FIGS. 5A-5F depict examples of initial permeabilities of the ensemble members (FIGS. 5A-5E) and a regression analysis (FIG. 5F) for the considered analysis displaying the strong heterogeneity of the initial ensemble.

FIGS. 6A-6B depict production levels of four producer wells for an exemplary multi-data incorporation (FIG. 6A) and with only production data (FIG. 6B) assimilated. FIGS. 6C and 6D depict regression analysis for the final permeability estimates for the multi-data incorporation (FIG. 6C) and only production data (FIG. 6D) exhibiting the estimation improvement. (red—real production curve, blue—mean of ensembles (gray)).

FIGS. 7A and 7B depict cumulative water cut levels for the reservoir formation comparing the multi-data incorporation (FIG. 7A) versus the incorporation of only production data (FIG. 7B) for the four wells. FIGS. 7C and 7D depict water cut levels for the individual producers for the two cases, multi-data incorporation (FIG. 7C) and only production data (FIG. 7D). (red—real production curve, blue—mean of ensembles (gray)).

FIGS. 8A-8D depict 58% (outer) and 60% (inner) saturation levels comparison for different years. Black contours indicate the saturation fronts for sole production data matching, red the water front contours incorporating multiple data and cyan the real saturation front.

FIGS. 9A-9F depict a comparison of permeability estimates (FIGS. 9A-9C) and its corresponding regression analysis (FIGS. 9D-9I) for different ensemble sizes.

### DETAILED DESCRIPTION

Described below are various embodiments of the present systems and methods for a reservoir forecasting application. Although particular embodiments are described, those embodiments are mere exemplary implementations of the system and method. One skilled in the art will recognize other embodiments are possible. All such embodiments are intended to fall within the scope of this disclosure. Moreover, all references cited herein are intended to be and are hereby incorporated by reference into this disclosure as if fully set forth herein. While the disclosure will now be described in reference to the above drawings, there is no intent to limit it to the embodiment or embodiments disclosed herein. On the contrary, the intent is to cover all alternatives, modifications and equivalents included within the spirit and scope of the disclosure.

In various embodiments, a reservoir forecasting application may be executed in a computing environment that may comprise, for example, a server computer or any other system providing computing capability. Alternatively, the computing environment may employ a plurality of computing devices that may be arranged, for example, in one or more server banks or computer banks or other arrangements. Such computing devices may be located in a single installation or may be distributed among many different geographical locations. For example, the computing environment may include a plurality of computing devices that together may comprise a hosted computing resource, a grid computing resource and/or any other distributed computing arrangement. In some cases, the computing environment may correspond to an elastic computing resource where the allotted capacity of processing, network, storage, or other computing-related resources may vary over time.

The reservoir forecasting application is executed to provide state and parameter estimation (including forecasting) over time of a reservoir such as a gas reservoir, oil reservoir, water reservoir, or other reservoir. To this end, the reservoir forecasting application may implement or otherwise simulate a geological model corresponding to a reservoir to be forecasted. The geological model may encode physical or geological attributes corresponding to a reservoir. These physical or geological attributes may include, for example, a geological structure, a number of wells, pressure, saturation, permeability, porosity, or other attributes.

The reservoir forecasting application may also implement a reservoir simulator based on the attributes encoded in the geological model. The reservoir simulator may be implemented using a MATLAB reservoir simulator toolbox (MRST), or other tool sets, libraries, or other functionality as can be appreciated. For example, the reservoir simulator may include a 2D or 3D finite difference black oil simulator MRST implementing a two-phase flow problem for the oil and water phase of a reservoir. The reservoir simulator may, for example, calculate predicted transformations to various attributes of the geological model over time. To this end, the geological model may comprise an initial state for the reservoir forecasting application to transform based at least in part on data generated by observation modules and a history matching and forecasting module, as will be described below. The reservoir simulator may also be implemented by another approach.

The reservoir forecasting application may provide output generated by the reservoir simulator to one or more observation modules to generate various data sets to be provided to a history matching and forecasting module as will be described. The observation modules may include, for example, a seismic survey module, an electromagnetic (EM) survey module, a gravimetric survey module, an interferometric synthetic aperture radar (InSAR) survey module, or other observation modules.

The seismic survey module is executed to transform porosity and saturation data into a velocity and density profile for a reservoir formation. Transforming porosity and saturation data into the velocity and density profile may be performed by applying a Biot petrophysical transformation or Gassmann petrophysical transformation to the porosity and saturation data, or by another approach. The seismic survey module may further calculate a time lapse seismic impedance profile from the velocity and density profile. The velocity profile, density profile, or the time lapse seismic impedance profile may be provided as an input to the history matching and forecasting module, or to other functionality of the reservoir forecasting application.

The EM survey module is executed to determine the resistivity response or formation conductivity of a reservoir formation. This may include, for example, performing one or more transformations to porosity data, saturation data, salt concentration data, or other data to formation conductivity. The formation conductivity may be expressed as a function of a discrete state or over time. Such transformations may be implemented according to Archie's Law, variants thereof, or other algorithms or approaches. The formation conductivity may then be provided to the history matching and forecasting module.

The gravimetric survey module is executed to determine time-lapse gravimetry capturing the measurement of spatio-temporal changes in the Earth's gravity field by performing repeated measurements of gravity and its gradients. A forward modeled gravimetric signal may then be provided to the history and forecasting module.

The InSAR survey module accesses time lapse interferometric synthetic aperture radar (InSAR) data measuring surface deformation over a large area caused by changes in a reservoir due to production and injection. The InSAR survey module may obtain the InSAR data from satellite sensors via a satellite network, wireless network, or other network as can be appreciated. The InSAR data may then be provided to the history and forecasting module.

The history matching and forecasting module predicts a forecasted reservoir state based on a given reservoir state provided by the reservoir simulator, as well as data generated by observation modules. The history matching and forecasting module may apply a recursive filter, such as an Ensemble Kalman Filter (EnKF) or a smoother, to this data to generate the forecasted reservoir state. The forecasted reservoir state may then be provided to the reservoir simulator. The reservoir simulator may then perform with the forecasted reservoir state as an initial state. To this end, the reservoir simulator, observation modules, and history matching and forecasting module may provide data to each other cyclically to forecast reservoir states over time.

Various applications and/or other functionality may be executed in the computing environment according to various embodiments. Also, various data may be stored in a data store that is accessible to the computing environment. The data store may be representative of a plurality of data stores as can be appreciated. The data stored in the data, for example, is associated with the operation of the various applications and/or functional entities described below. Additional disclosure may further be found in the paper “Multi-Data Reservoir History Matching Enhanced Reservoir Forecasts and Uncertainty Quantification” by Klemens Katterbauer, Ibrahim Hoteit, and Shuyu Sun (Appendix A, hereto) which is hereby incorporated by reference in its entirety.

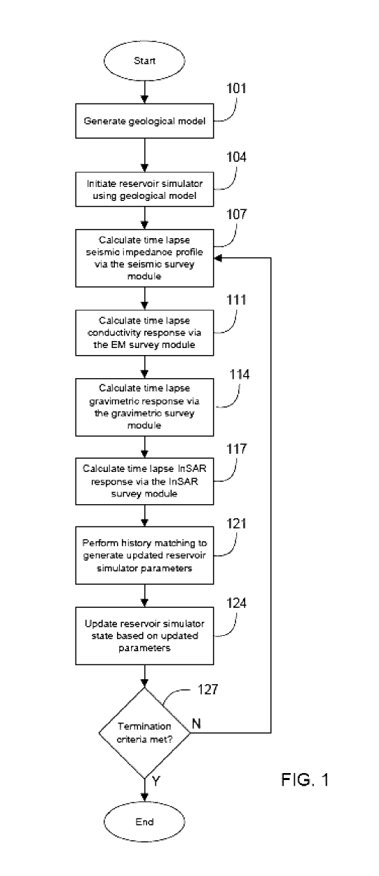

Referring next to FIG. 1, shown is a flowchart that provides one example of the operation of a portion of the reservoir forecasting application according to various embodiments. It is understood that the flowchart of FIG. 1 provides merely an example of the many different types of functional arrangements that may be employed to implement the operation of the portion of the reservoir forecasting application as described herein. As an alternative, the flowchart of FIG. 1 may be viewed as depicting an example of elements of a method implemented in a computing environment according to one or more embodiments.

Beginning with box 101, the reservoir forecasting application generates a geological model. This may include, for example, loading a predefined geological model from a data store, initializing a new geological model by defining one or more geological model attributes, or another approach. As a non-limiting example, geological model attributes may include a geological structure. The geological structure may include one or more of fault layers, rock formation fluid type, etc. The geological model may also specify the well information, including for example a number of wells. The geological model may also include initially assumed parameters, such as pressure, saturation, permeability, porosity, or other attributes of a reservoir to be provided to a reservoir simulator.

Next, in item 104, the attributes or parameters are transferred to a reservoir simulator and the reservoir forecasting application initializes the reservoir simulator using the geological model. This may include defining or initializing one or more data parameters of the reservoir simulator as a function of corresponding attributes encoded in the geological model. Initializing the reservoir simulator may include executing or initializing a process or application corresponding to the reservoir simulator in a computing environment distinct from the reservoir forecasting application. In such an embodiment, the reservoir forecasting application may be configured to communicate with or provide data to the separate reservoir simulator application. In other embodiments, the reservoir simulator may be initialized as functionality encapsulated within the reservoir forecasting application. The reservoir forecasting application may also be initialized by another approach.

Moving on to box 107, the reservoir forecasting application determines (for example calculates) a time lapse seismic impedance profile via the seismic survey module. This may include, for example, providing saturation data, porosity data, or other data embodied in the geological model to the seismic survey module. The seismic survey module may then calculate the time lapse seismic impedance profile by applying a petrophysical transformation to porosity and saturation data to generate a velocity and density profile. Such petrophysical transformations may include a Biot transformation, a Gassmann transformation, or another petrophysical transformation as can be appreciated.

In box 111, the reservoir forecasting application calculates the time lapse conductivity response via the EM survey module. This may include calculating formation conductivity by applying Archie's Law, variants thereof, or other approaches, to porosity, saturation and salt concentration data embodied in the geological model, obtained from the reservoir simulator, or otherwise accessible to the EM survey module. Formation conductivity may also be calculated with respect to a previously sampled conductivity to calculate the time lapse conductivity response. The time lapse conductivity response may also be calculated by another approach.

Next, in box 114, the reservoir forecasting application calculates the time lapse gravimetric response via the gravimetric survey module. This may include, for example, measuring gravity and gradients as a function of saturation data, porosity data, or other data embodied in the geological model, obtained from the reservoir simulator, or otherwise accessible to the EM survey module. Gravity and gradient measurements may be calculated with respect to previously sampled gravity or gradient measurements to calculate the time lapse gravimetric response. The time lapse gravimetric response may also be calculated by another approach.

In box 117, the reservoir forecasting application calculates the time lapse InSAR response via the InSAR survey module. This may performed based at least in part on, for example, pressure data or other data embodied in the geological model.

Calculating the time lapse InSAR response may include calculating surface displacements at one or more points according to the pressure data. InSAR responses may be calculated with respect to previously calculated InSAR responses to determine a time lapse InSAR response.

The reservoir forecasting application then, in box 121, invokes the history matching and forecasting module to perform history matching on various data parameters. Such data parameters may include, for example, those data parameters calculated in boxes 107-117, data embodied in the geological model, attributes or other data points calculated or generated by the reservoir simulator, or other data. Performing history matching may include calculating updated parameters for the reservoir simulator based on the data operated upon by the history matching and forecasting module. For example, performing the history matching may include calculating updated permeability data, porosity data, pressure data, saturation data, or other data as can be appreciated. The updated parameters may be calculated by applying a Bayesian data assimilation technique, such as an Ensemble Kalman Filter or smoother, a Singular Evolutive Interpolated Kalman Filter, or another approach.

Next, in box 124, the reservoir forecasting application updates the reservoir simulator state based on the updated parameters generated in box 121. This may include, for example, redefining or re-instantiating parameterized data of the reservoir simulator according to the updated parameters. This may also include invoking or performing one or more operations of the reservoir simulator to generate the updated state. After updating the reservoir simulator state, in box 127, the reservoir forecasting application determines if a termination criteria has been met. As a non-limiting example, termination criteria may include a number of iterative steps performed by the reservoir forecasting application meeting or exceeding a threshold, a passage of a predefined interval, a forecasting state corresponding to a time period meeting or exceeding a threshold, or other criteria. If a termination state has not been met, the process returns to box 107. Otherwise, the process ends.

### Example

As a non-limiting example, we present below a multi-data history matching framework for a water drive oil reservoir incorporating production, seismic, EM, gravity and InSAR data. Based on the Ensemble Kalman Filter, the impact of the individual observations was obtained via an adjoint free sensitivity analysis displaying the impact of different data have on the forecasting impact. For this particular example, the analysis indicates that production, seismic and electromagnetic observations have strong impact on the updated states while gravimetric data exhibit a weak impact as deductable from the small density contrast between the injected water and displaced hydrocarbons. The developed framework provides a platform for synergizing multiple observation data for enhanced history matches and forecasts, joining the forces of different departments.

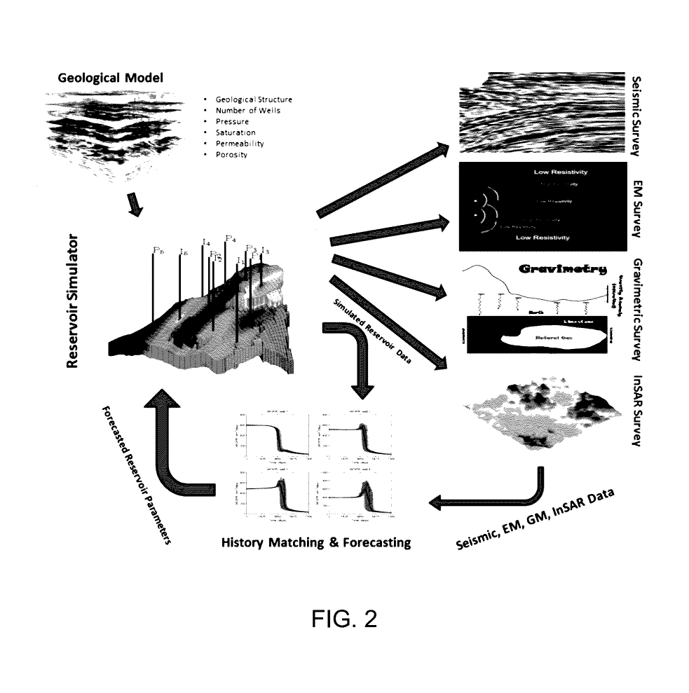

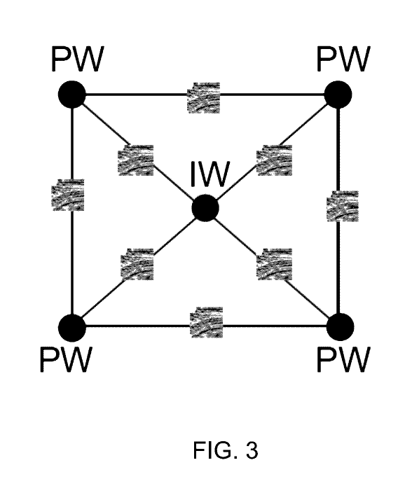

An exemplary framework is presented in FIG. 2. The framework integrates a 2D finite difference black oil reservoir simulator MRST [27] together with 4D seismic and electromagnetic survey modules that are complemented by a time lapse gravity and InSAR survey module. The reservoir simulator and the survey modules can then be interfaced to the EnKF together with a sensitivity analysis module.

### Reservoir Simulation

The 2D finite difference black oil reservoir simulator couples a well model to the two-phase flow problem for the oil and water phase given by the system of equations [28]

$$\begin{matrix}∇ \cdot υ = q , v = - K [ λ ∇ p + ( {λ}_{w} {ρ}_{w} + {λ}_{g} {ρ}_{g} ) g ∇ z ] \\ and & ( 1 ) \\ φ \frac{\partial {s}_{w}}{\partial t} + ∇ \cdot ( {f}_{w} ( {s}_{w} ) [ υ + {λ}_{g} ( {ρ}_{g} - {ρ}_{w} ) gK ∇ z ] ) = {q}_{w} & ( 2 )\end{matrix}$$

where ρ_{g}, ρ_{w} denotes the density of the gas and water phase, λ_{g}, λ_{w} the mobilities, f_{w} the fractional flow of the water phase and s_{w} the water saturation with 1=s_{g}+s_{w}. Furthermore, q represents the flux, v Darcy's velocity, g the gravity, K the permeability tensor and p the pressure within the reservoir. The system is solved sequentially via solving Equation 1 for fixed saturation values for fluxes and pressure and then evolve the saturations with the computed fluxes and pressure levels according to Equation 2.

The seismic surveys transform porosity and saturation via Biot petro-physical transformation [29] into the velocity and density profile of the formation. Biot's theory [30, 29] deals with the propagation of acoustic waves in fluid-saturated porous solids and have been extensively applied in estimating acoustic wave velocities in fluid-saturated media [31]. The theory provides a framework for predicting the frequency-dependent velocities of saturated rocks in terms of dry-rock properties that enables also to estimate the reservoir compaction caused by the oil extraction via Biot's poroelasticity theory [29], or to its simpler variant, Gassmann's equations that are valid in the flow-frequency limit. The main assumptions of Biot's theory are that the underlying rocks are isotropic and that all minerals making up the rock structure have the same bulk and shear moduli [30]. While Gassmann's equations have been widely used due to its simplicity and correspond to the Biot-velocities in the low-frequency limit, for high-frequency seismic waves, as encountered in seismic imaging, Gassmann's equation underestimate velocities by around 10% [32], that may for the full acoustic wave propagation solvers lead to significantly distorted seismograms and hence misrepresentation of the formation structure. For the underlying reservoirs and cross-well seismic tomography applications, the high-frequency assumption is valid [33] and the P-wave and S-wave velocity is represented by [29, 5]

$$\begin{matrix}{V}_{P ∞} = \sqrt{\frac{Δ + \sqrt{{Δ}^{2} - 4 ( {ρ}_{11} {ρ}_{22} - {ρ}_{12}^{2} ) ( PR - {Q}^{2} )}}{2 ( {ρ}_{11} {ρ}_{22} - {ρ}_{12}^{2} )}} & ( 3 ) \\ {V}_{S ∞} = \sqrt{\frac{{μ}_{r}}{ρ - {φρ}_{fl} {α}^{- 1}}} & ( 4 )\end{matrix}$$

where Δ, P, R, Q and ρₘ ρ₁₂, ρ₂₂ are parameters computed from the effective bulk Kᵣ and shear moduli of the rock μᵣ, the porosity φ, the density of the rock ρ and fluid ρ_{fl} and the turtuosity parameter α.

### Electromagnetic Survey

In order to determine the resistivity response of the formation, we trans-form porosity, saturation and salt concentration to formation conductivity using variants of Archie's Law. Archie's Law states that the logarithmic conductivity is related linearly to the logarithm of porosity and saturation, mathematically stated as

log(σ)=log(C_{w})+m log(kφ)+n log(S) (5)

with C_{w} being a scaled water conductivity and φ and S the porosity and saturation. The parameters m, n and k are empirically defined constants. Within the simulations, the original expression of Archie's was assumed with m=n=−2 and k=1 [34]. The conductivity for the injected water C_{w} given by the IJWC-Equation [35]

$${C}_{w} = {[ ( 123 \times {10}^{- 4} + \frac{36475}{10 {S}_{wc}^{0.955}} ) \frac{82}{1.8 T + 39} ]}^{- 1} , \qquad ( 6 )$$

where S_{wc} is the salt concentration (in ppm) and T the temperature (in celsius) in the formation. The time lapse conductivity change is then incorporated into the observation operator of the EnKF for subsequent updating.

### Gravimetry

Time-lapse gravimetry is the measurement of spatio-temporal changes in the Earth's gravity field via performing repeated measurements of gravity and its gradients. Local changes in the gravity field are the result of subsurface mass re-distributions that require however μGal precision for detecting these small changes. For the forward modeling of the gravimetric signal we have employed the commonly encountered approach to represent the reservoir formation via a number of rectangular prism and utilize the expression for the gravitational attraction given by Flury [36]

$${g}_{l , j} ( {X}^{*} ) = {G}_{ρ l , j}^{b} {\vert {\vert {\vert - x log ( y + r ) - y log ( x + r ) + z arctan ( \frac{xy}{zr} ) \vert}_{{x}_{lb}}^{{x}_{ub}} \vert}_{{y}_{lb}}^{{y}_{ub}} \vert}_{{z}_{lb}}^{{z}_{ub}} \qquad ( 7 )$$

where gₗ,j(X*) is the gravitational attraction of the reservoir cell i at time tₗ, G the gravitational constant

$$6.67 \times {10}^{- 11} {N ( \frac{m}{kg} )}^{2} , and p \frac{b}{{l}_{j}}$$

is me cell bulk density at time tₖ.

The prism-bounding coordinates x_{ub},x_{lb},y_{ub},y_{lb},z_{ub},z_{lb} are all measured relative to the observation point X*=(x*, y*, z*), with z values increasing for with rising depth and r=\sqrt{x²+y²+z²}. The total gravitational attraction of the reservoir formation is then represented via

$${g}_{l} ( {X}^{*} ) = {\sum }_{j = 1}^{M} {g}_{l , j} ( {X}^{*} ) \qquad ( 8 )$$

where M is the reservoir cell number. The bulk density for each grid-cell can be represented via

ρ_{l,j}^{b}=φⱼρ_{l,j}^{fl}+(1−φj)ρ^{m} (9)

where φⱼ denotes the porosity, p_{l,k}^{fl} the fluid density of cell j, and p^{m} the rock-matrix density. The fluid density is given by

ρ_{l,j}^{fl}=s_{l,j}^{w}ρ_{l,j}^{w}+s_{l,j}^{g}ρ_{l,j}^{g} (10)

with s_{l,j}^{w}, s_{l,j}^{g} representing the water- and gas saturations for cell j, as well as p_{l,j}^{w}, p_{l,j}^{g} the water- and gas-cell densities at time tₗ. The time-lapse gravity variation can then be computed from

Δgₗ(X*)=gₗ(X*)−g₀(X*) (11)

where gₗ represents the gravity measurements at time tₗ and g₀ denotes the baseline gravity measurements.

### InSAR

Time lapse interferometric synthetic aperture radar (InSAR) is a modern satellite technique for the accurate measurement of surface deformation over a large area that is caused by changes in the reservoir due to production and injection. InSAR has been increasingly used in the context of reservoir monitoring [37], displaying its capability to obtain millimetric resolution over large area caused by changes in the reservoir pressure on real fields such as the Tengiz gas field in Kazakhstan [38] and the Krechba Field in Algeria [18]. Surface deformation (subsidence and uplift) caused by the injection and production of fluids from subsurface reservoirs has been a well-known phenomenon starting with observations of massive subsidence on top of some major oil fields [39] and is primarily caused by a change in the pressure levels within the reservoir [40]. The surface displacement at a point x induced via changes in the reservoir pressure is expressed as [41]

u^{INSAR}(x)=∫_{Ω}ε(y)G(x,y)dy (12)

where the volumetric eigenstrain is represented by

$$ε ( x ) = \frac{B Δ p ( x )}{3 K} \qquad ( 13 )$$

with B being the reservoir Biot coefficient, and K the drained moduli. G represents the fundamental solution for the displacement at the observation point x produced by a point dilation at y [41]. Discretizing the above integral with respect to the individual reservoir cells the expression for the surface displacement for the individual reservoir prisms is represented by [18]

$${u}^{INSAR} ( x ) = {\sum }_{j = 1}^{M} {ε}_{j} {\int }_{{Ω}_{j}} G ( x , y ) d y \qquad ( 14 )$$

where M is the number of reservoir prisms and

$${ε}_{j} = \frac{B Δ pj ( x )}{3 K}$$

the volumetric eigenstrain in the j-th prism displaying the strain effect caused by the reservoirs pressure change.

### History Matching & Adjoint Free Sensitivity Analysis

For the history matching framework we implemented the EnKF. The state-space formulation for the reservoir history matching problem is given by

xₖ₊₁=Mₖ(xₖ,cₖ)+ηₖ (15)

yₖ=hₖ(xₖ)+εₖ (16)

where Mₖ represents the reservoir simulation model with the state vector xₖ consisting of the static parameters, permeability and porosity and dynamic variables, pressure and saturation, cₖ consisting of reservoir temperature, ηₖ a term modeling the model noise and yₖ the observation vector obtained via the nonlinear observation function hₖ that is perturbed by a Gaussian random noise εₖ. The observation operator encompasses production data, time lapse seismic, EM, gravimetry and InSAR data.

The EnKF was first introduced by Evensen et. al. [42], and has been ever since extensively applied in the field of reservoir history matching [1, 4]. Being fundamentally based on the Kalman Filter (KF), the EnKF differs from the KF in terms of that the distribution of the system state is represented by a collection, or ensemble, of state vectors approximating the covariance matrix of the state estimate by a sample covariance matrix computed from the ensemble. Despite the fact that the EnKF updates are based on only means and covariances (i.e., second order statistics neglecting higher order moments of the joint probability density distribution of the model variables) and these covariances are computed from a finite size ensemble, the EnKF has shown to work remarkably well and efficiently for a variety of problems compared to other algorithms [1]. Seeking an efficient method, achieving good matching for a variety of different problems, the EnKF has naturally become the method of choice for reservoir history matching.

In order to achieve efficient computation and to handle the nonlinear observations, we employed an observation matrix-free implementation of the EnKF. Let Nₑ be the ensemble size and Xₖ=[x_{1,k}, . . . , x_{N}_{ₑ}_{,k}] the state ensemble matrix at the k-th iteration step, with x_{i,k} denoting the state vector of the i-th ensemble member at the k-th time step. Further, define the scaled covariance anomaly

$${A}_{k} = {X}_{k} - \frac{1}{{N}_{e}} ( {\sum }_{i = 1}^{{N}_{e}} {x}_{i , k} ) {e}_{1} \times {N}_{e}$$

with e₁×Nₑ denoting the matrix with ones as elements and size 1×Nₑ and

$${[ {H}_{k} ]}_{: , i} = {h}_{k} ( {x}_{i , k} ) - \frac{1}{{N}_{e}} {\sum }_{j = 1}^{{N}_{e}} {h}_{k} ( {x}_{j , k} )$$

the matrix observation matrix with hₖ(x_{j,k}) being the nonlinear observation for the i-th ensemble state vector. Then for the data matrix Dₖ, and its corresponding ensemble covariance matrix Dₖ, the EnKF update step can be written as:

$${X}_{k}^{a} = {X}_{k}^{f} + \frac{1}{{N}_{e} - 1} {A}_{k} {{H}_{k}^{T} ( \frac{1}{{N}_{e} - 1} {H}_{k} {H}_{k}^{T} + {R}_{k} )}^{- 1} ( {D}_{k} - {h}_{k} ( {X}_{k}^{f} ) ) \qquad ( 17 )$$

with Xₖ^{f} being the forecasted ensemble state obtained by integrating each ensemble member in time with the reservoir simulator [43], given by function Mₖ. For further details about the EnKF, the reader may refer to the review article of Aanonsen et. al. [1] for a detailed discussion.

With rising observation data being incorporated into data assimilation systems, it has become important to determine the information content each new observation data set has and what its relative influence is on the state estimation in the analysis step. We have followed the approach presented by Liu et al. [25], where an adjoint-free approach for computing the analysis sensitivity (self-sensitivity) for an EnKF update step was presented. For the case of linear observations, the analysis state is represented via

x^{a}=Ky^{a}+(I_{N}−KH)x^{f} (18)

with the Gain matrix K given by K=PH^{T}(HPH^{T}+R)⁻¹ being a com-position of the error covariance matrix and the observation error covariance, and H the observation matrix. The sensitivity of the analysis vector x^{a} to the observation vector y⁰ is given by

$${S}^{o} = \frac{\partial {y}^{a}}{\partial {y}^{o}} = {K}^{T} {H}^{T} = {R}^{- 1} {HPH}^{T} \qquad ( 19 )$$

and the sensitivity with respect to the forecasted state is given by

$${S}^{f} = \frac{\partial {y}^{a}}{\partial {y}^{f}} = {I}_{m} - {K}^{T} {H}^{T} = {I}_{m} - {S}^{o} \qquad ( 20 )$$

As shown in Cardinali et al. [44] the sensitivity of the analysis to the observation and the sensitivity of the analysis to the corresponding forecasted state are complementary and the diagonal elements of the sensitivity matrix (self-sensitivity values) are theoretically between 0 and 1.

For nonlinear and implicitly given observations the sensitivity matrix can be written as [25]

$${S}^{o} = \frac{{N}_{e} - {1}^{- 1}}{R} ( {HX}^{a} ) {( {HX}^{a} )}^{a} \qquad ( 21 )$$

where the i-th column of the analysis perturbation column is given by

$${HX}^{a , i} = h ( {x}^{a , i} ) - \frac{1}{{N}_{e}} {\sum }_{i = 1}^{{N}_{e}} h ( {x}^{a , i} ) \qquad ( 22 )$$

Written more explicitly the observation sensitivity can be written as

$$\begin{matrix}{S}_{jj}^{a} = \frac{\partial {y}_{j}^{a}}{\partial {y}_{j}^{a}} = ( \frac{1}{{N}_{e} - 1} ) \frac{1}{{σ}_{j}^{2}} {\sum }_{i = 1}^{{N}_{e}} [ {( {HX}^{a , i} )}_{j} \times {( {HX}^{a , i} )}_{j} ] \\ and & ( 23 ) \\ {S}_{ji}^{o} = \frac{\partial {y}_{i}^{a}}{\partial {y}_{j}^{a}} = ( \frac{1}{{N}_{e} - 1} ) \frac{1}{{σ}_{j}^{2}} {\sum }_{i = 1}^{{N}_{e}} [ {( {HX}^{a , i} )}_{j} \times {( {HX}^{a , i} )}_{i} ] & ( 24 )\end{matrix}$$

with σⱼ² the j-th observation error variance.

### Simulation

The following section provides an extensive study and analysis of multi-data reservoir history matching that includes a sensitivity analysis determining the impact of different observational data.

### Setup

The studied reservoir is 2 km in both x and y-direction and 25 m in the z direction, representing a cenozoic sedimentary rock reservoir structure commonly found on the Arabian peninsula [45]. The grid size is 40×40×1. The reservoir rock is assumed to consist of sandstones with porosity and permeability values, linked by a poro-perm relationship. 300 ensembles were generated, with the permeability values obtained using SGEMS via unconditional simulation incorporating an exponential variogram model. The variogram has two anisotropy axis with ranges 850 m and 600 m, a sill of 10000 mD² and a nugget of 100 mD². The porosity values were obtained from the permeability fields via a log-transformation with

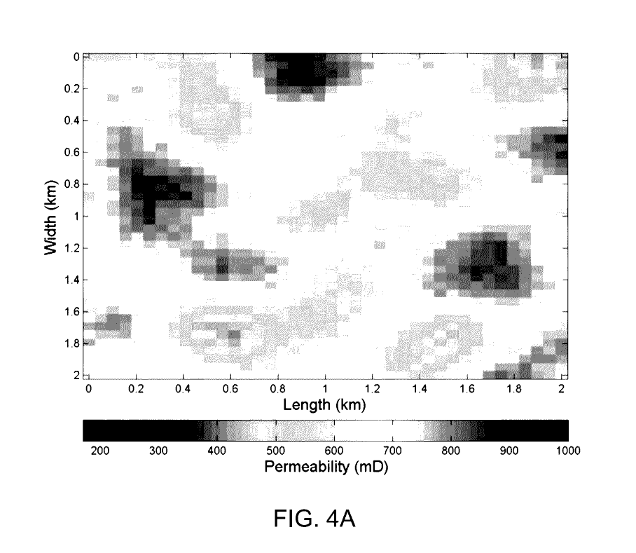

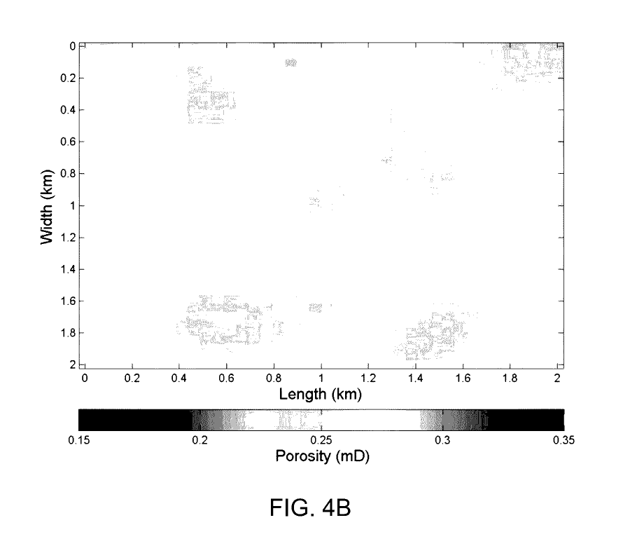

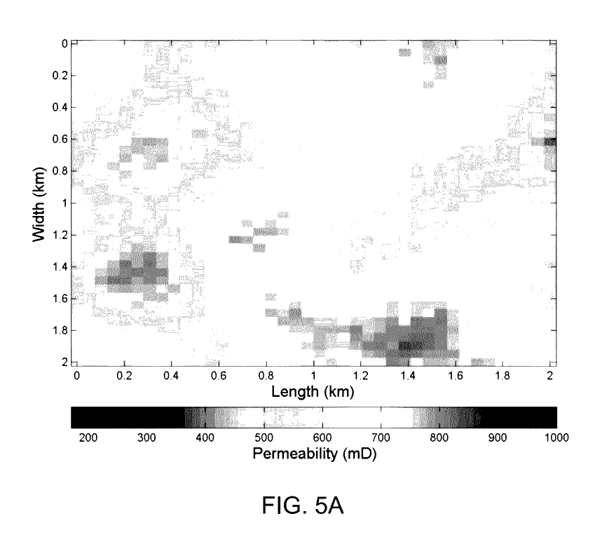

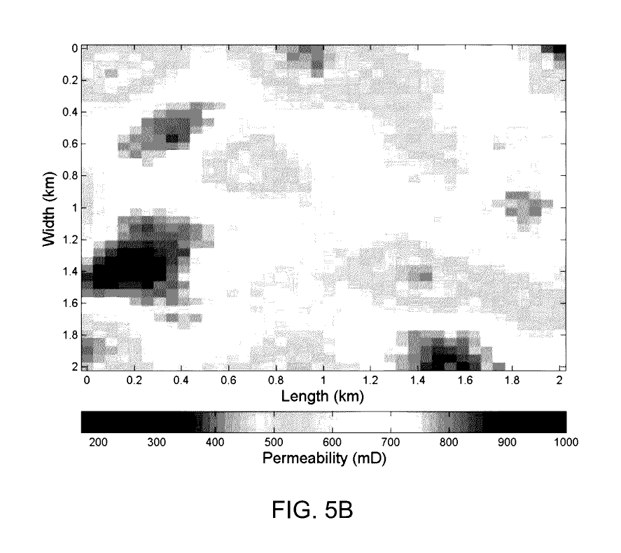

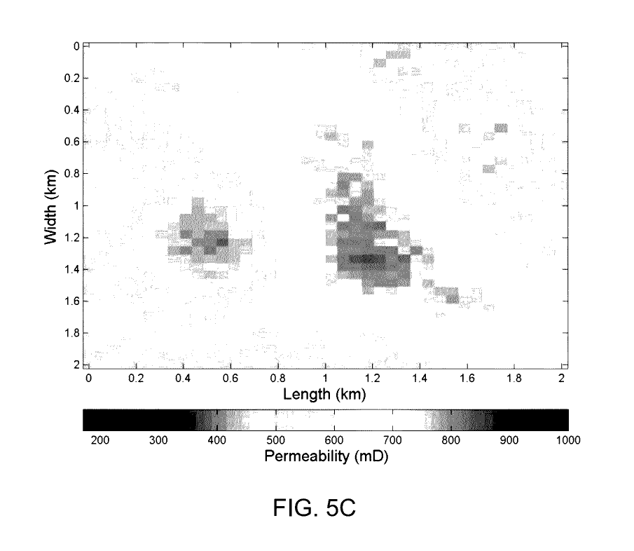

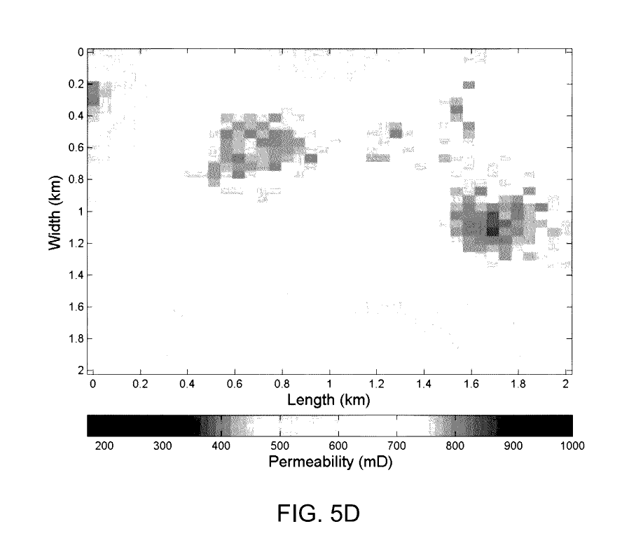

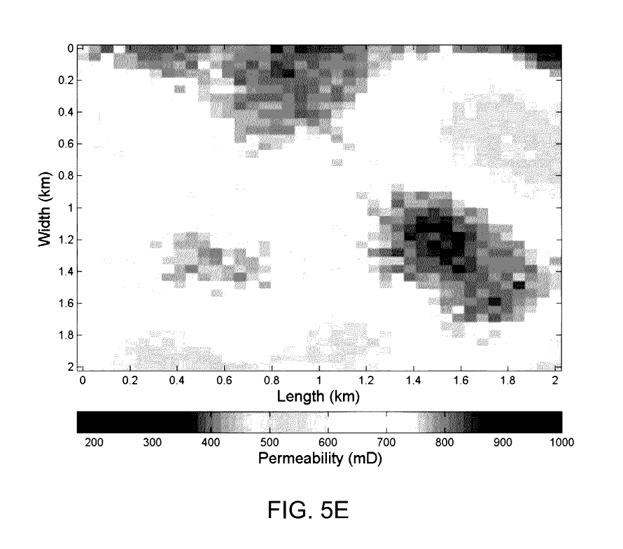

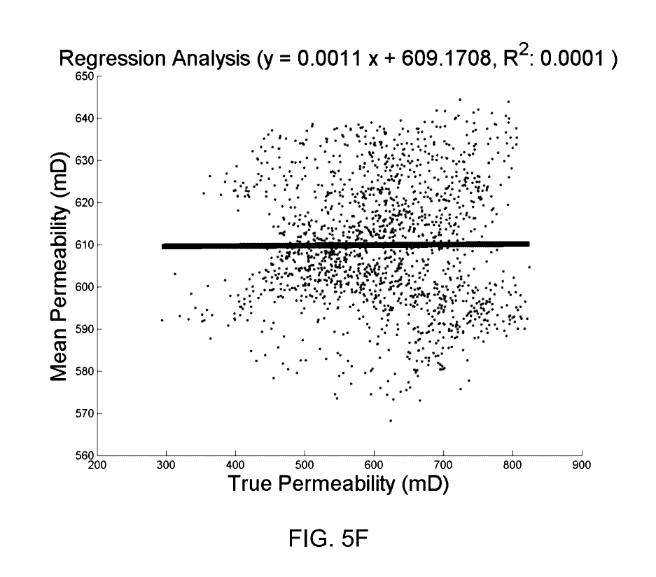

a=bφ=log(K) (25)

where φ is the porosity, K the permeability and a and b are equal to 4.3618 and 6.3648. The obtained permeability values range from 177 to 1000 milli darcy, and the porosities are in the range from 0.1283 to 0.35. (see FIGS. 4A and 4B) In FIGS. 5A-5F different initial ensemble permeability fields are presented outlining the strong heterogeneity and variation between the individual members. The permeability tensor was assumed diagonal with K_{zz}=Kₓₓ/15=K_{yy}/15. The well pattern we considered is a typical five-spot pattern (see FIG. 3) that is commonly used for oil field development [46], consisting of one injector in the center and four producers at the corners. The patterns structure furthermore enables easy extrapolation of the results to the whole field. The initial pressure levels within the reservoir were set at 5070 psi, ensuring during the simulations due to the adjustment of the pressure levels in the injected fluid that the producing wells maintain a pressure level of 4350 psi.

The above described realistic 2D reservoir test case is then employed in a series of history-matching experiments that were employed for forecasting production and pressure levels and the reservoir evolution, incorporating production, seismic and electromagnetic measurements. Bottom hole pressure (BHP), water cut ratio (WCR) and production flux were measured at all wells, with standard measurement errors of 370 psi for BHP, and around 7% measurement error rates for the other production data. For seismic, electromagnetic, gravity and INSAR measurements we have assumed error rates of around 10%.

We investigated for the 2D reservoirs different scenarios (shown in Table 1) that differ in their total simulation time, history matching time and the update times. Production data are collected every 30 days, and during each update step electromagnetic and seismic surveys were conducted. The time frames during which updates are performed conform to industry practices where cross-well Seismic and EM surveys may be conducted and are economically justified every three to seven years [49], while InSAR and Gravity surveys are conducted in similar time frames [14].

TABLE 1
Parameters of the test cases for
the reservoir considered for analysis.
(TSim = total simulation time, HMT = history
matching time, UT = update time)
Test case parameters (2D Reservoir)

| Case | TSim (years) | HMT (years) | UT (years) |
|---|---|---|---|
| 1 | 32 | 6 | 5 |
| 2 | 25 | 6 | 5 |
| 3 | 29 | 5 | 4 |
| 4 | 35 | 7 | 4 |
| 5 | 40 | 7 | 5 |

The matching improvements were obtained via comparing the Root-mean squared errors

$$RMSE = \sqrt{\frac{{\sum }_{i = 1} {N ( {y}_{i}^{true} - {y}_{i}^{est} )}^{2}}{N}} \qquad ( 26 )$$

for the individual cases. In Eq. (26) yᵢ^{true} is the i-th component of the considered true attribute, and yᵢ^{est} is its corresponding estimate obtained from the ensemble.

### Analysis

We first investigated the improvements the incorporation of multiple data has on the estimation of essential reservoir parameters, followed by a more detailed analysis of the reservoir evolution that is concluded by a sensitivity analysis determining the impact each observation type has on the estimation improvement.

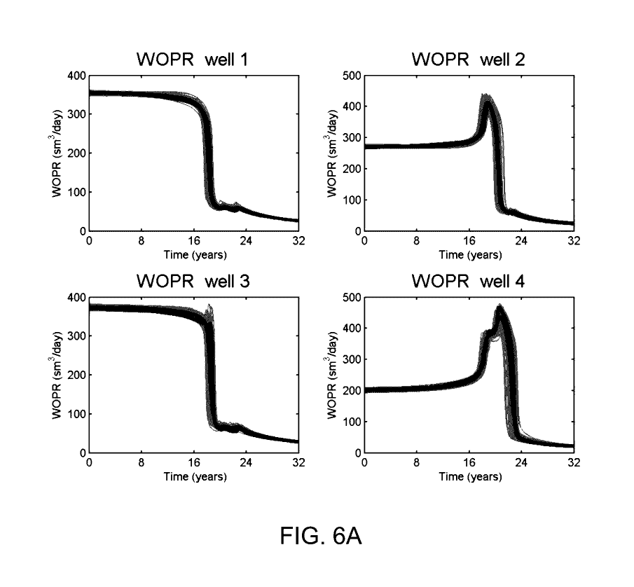

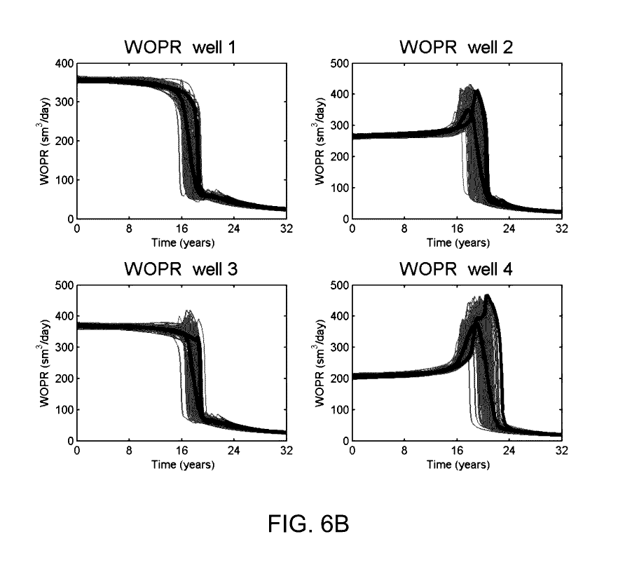

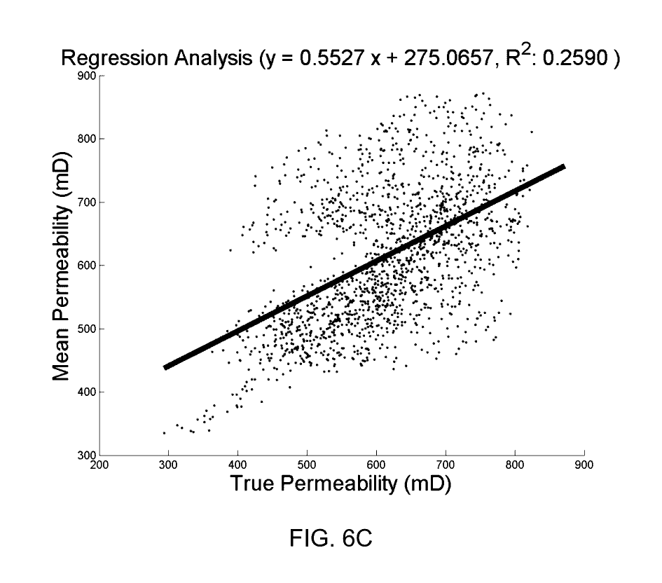

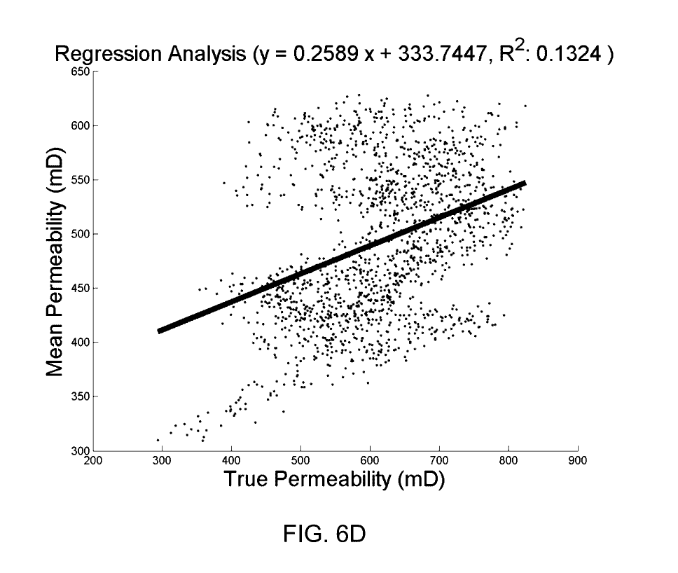

FIGS. 6A-6D present a comparison of the oil production for the four producing wells and a regression analysis for the final permeability estimates. Forecasting of oil production and the accurate estimation of permeability are quintessential for the optimization of oil recovery from the producing field and accurate formation interpretations. As observable from FIGS. 6A and 6B, ensemble spread decreases significantly if multiple data are incorporated (FIG. 6A) versus sole production data (FIG. 6B) matching, leading to a substantial uncertainty reduction. The contrast and reduction in production uncertainty is especially visible for the fourth producing well, where in the case of only production data being assimilated, the sharp drop in production caused by water influx differs by almost 6 years for the different ensemble members as compared to only 2 years when multiple data are assimilated. This strong deviation is also reflected in the poor estimate (blue) of the true field (red) that may predict a drop in the oil production around 2 years earlier and fails to capture the rapid increase in production. Failing to capture the more than doubling in the production levels may significantly strain resource, require emergency measures to adjust output levels and may lead to damaging the quality of the well and undesirable fluid displacement.

To understand further the cause for the strong displacement, we show at the bottom in FIGS. 6C and 6D a regression analysis of the estimated permeabilities for the two considered cases. A comparison between the two regression analysis indicates a stronger linear relationship between the estimated and true permeabilities as compared to the incorporation of spatially sparse production data. This is confirmed by the computation of the goodness of fit coefficient R2 that almost doubles for the incorporation of the multiple observational data besides production data. Concluding, accurate determination of the permeability of the under lying formation has been crucial to understand displacement patterns within the reservoir and to forecast their displacement, as the velocity of the fluid is related to the pressure difference via Darcy's equation where permeability as a multiplicative component of the gradient of pressure acts as a scaling factor.

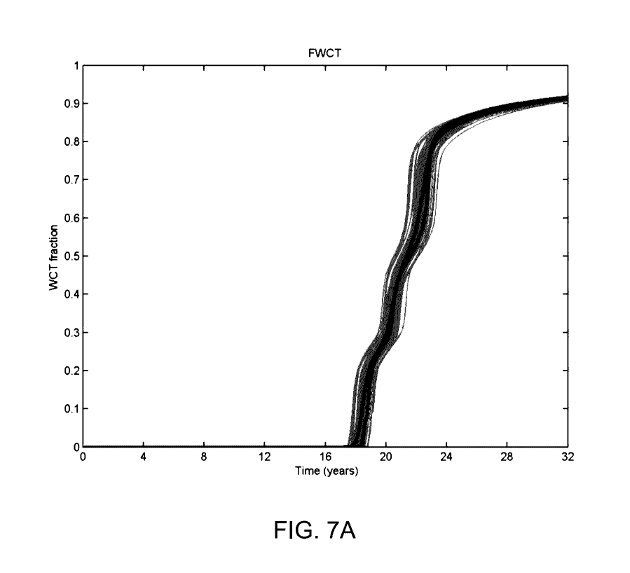

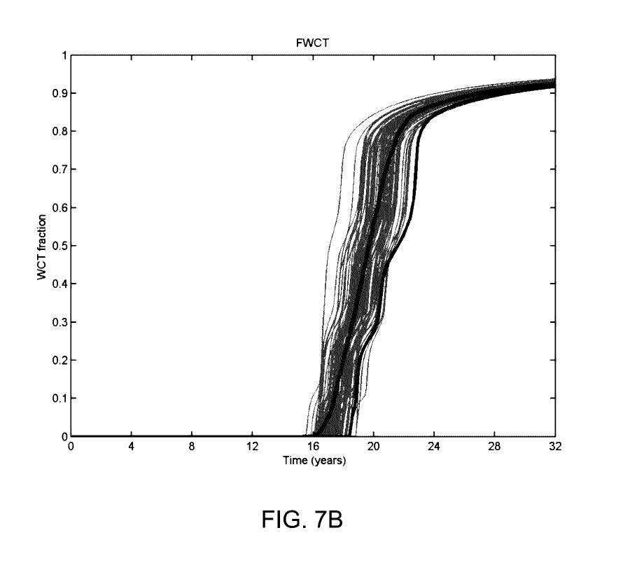

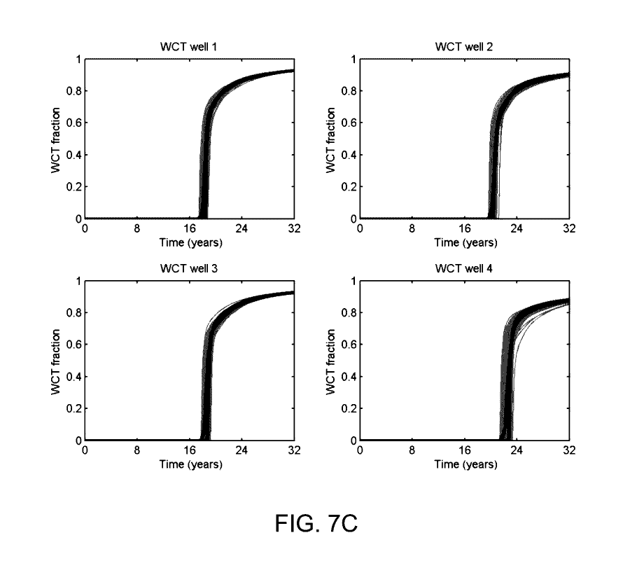

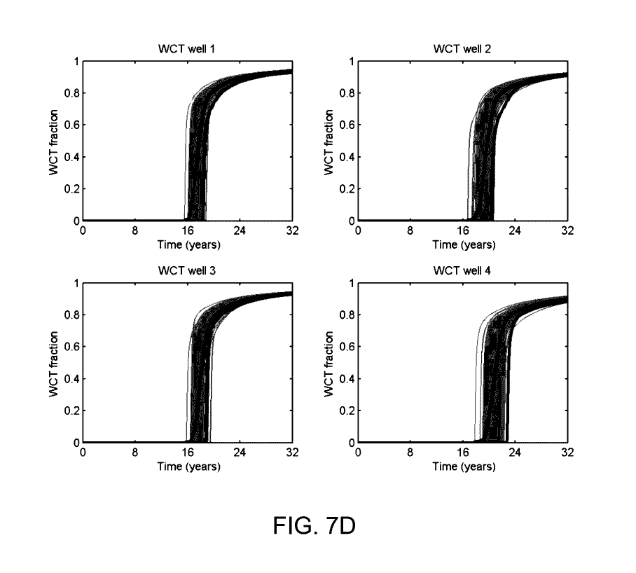

To further exhibit the potential benefits of assimilating several data sets, we present in FIGS. 7A-7D the cumulative water cut levels (FIGS. 7A and 7B) and the water cut levels for the four producer wells (FIGS. 7C and 7D). As for the production levels, the incorporation of multiple observational data reduces uncertainty and achieves a tighter matching as compared to production data matching, that may estimate a decommissioning around two years earlier than necessary, hence leading to shortfalls in recoverable oil.

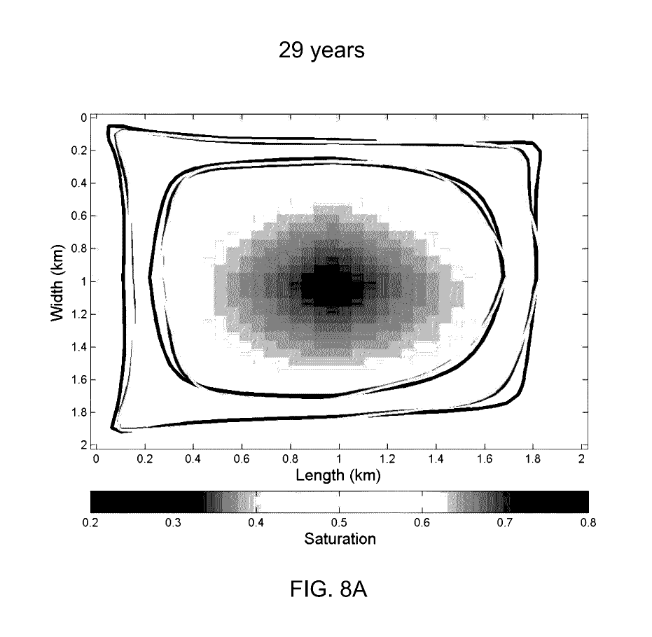

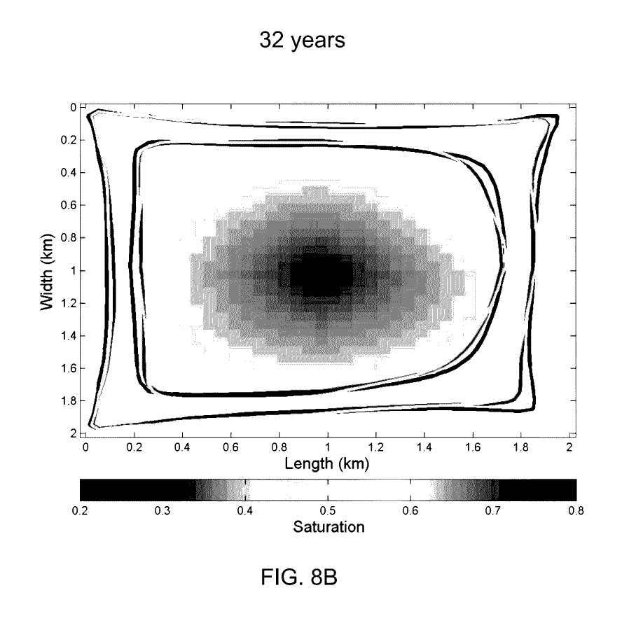

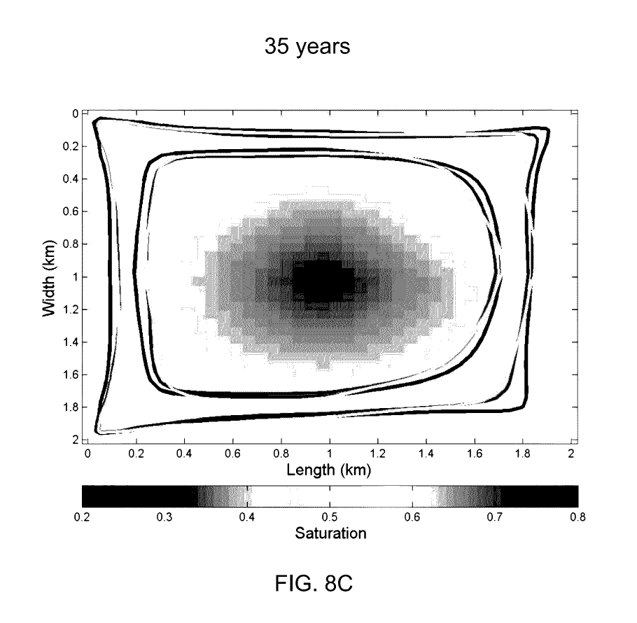

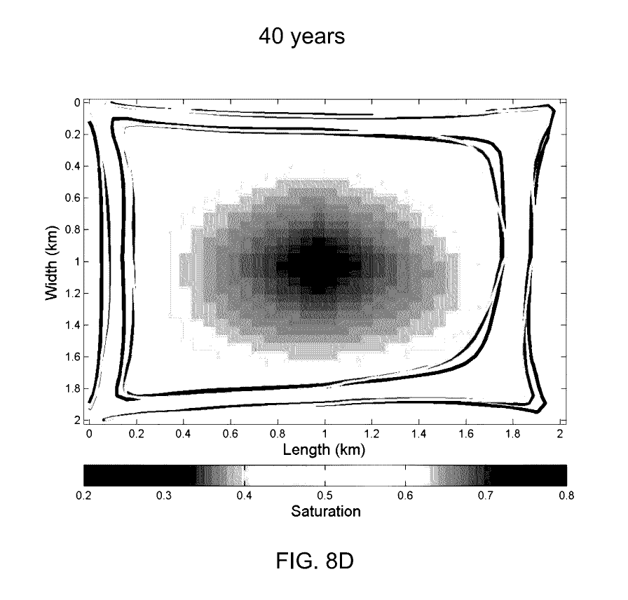

FIGS. 8A-8D presents the saturation fronts for different times comparing the true saturation fronts versus the multi-data estimated front and sole production data cases. The incorporation multiple observations significantly improves trackability of the saturation fronts and a closer alignment of the estimated fronts (red curves) to the real field. As shown previously, the more accurate estimates of the permeability and porosities are reflected in the enhanced tracking of the water propagation fronts. A closer analysis of the fronts reveals that difference between sparse well observations and multiple data may be as much as 100 meters implying for a domain size of 2000 meters an almost 5% difference.

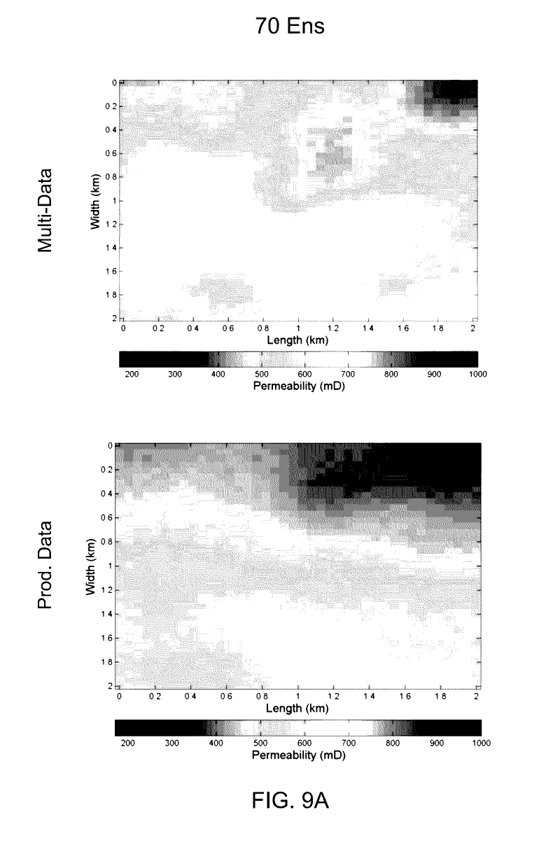

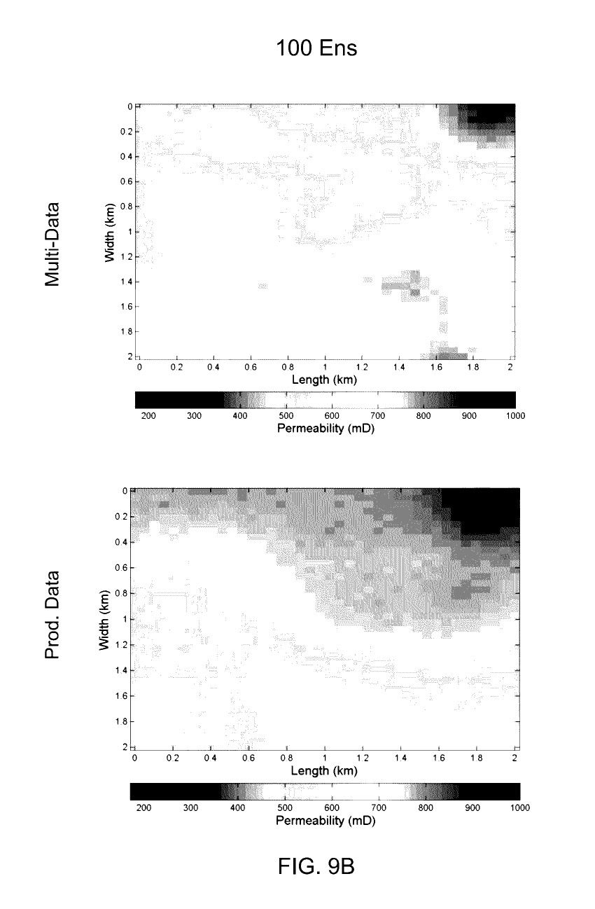

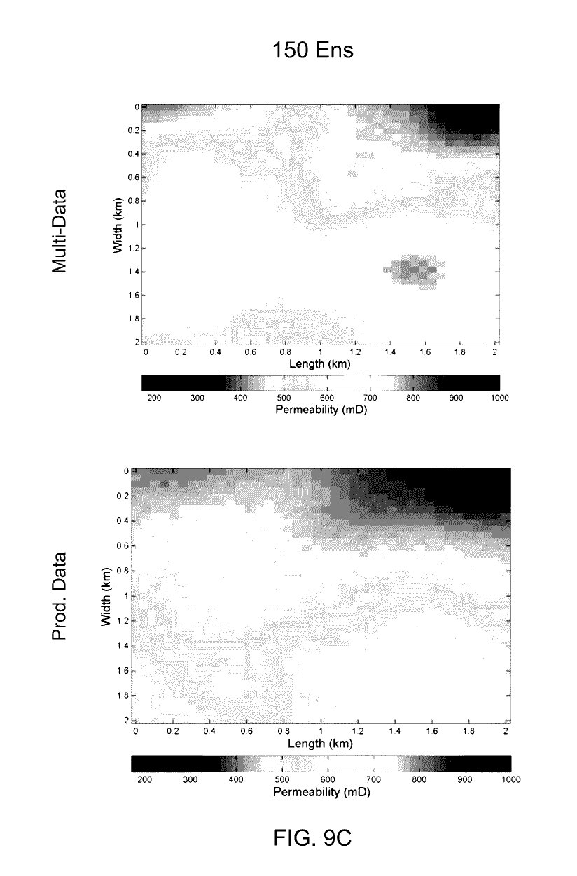

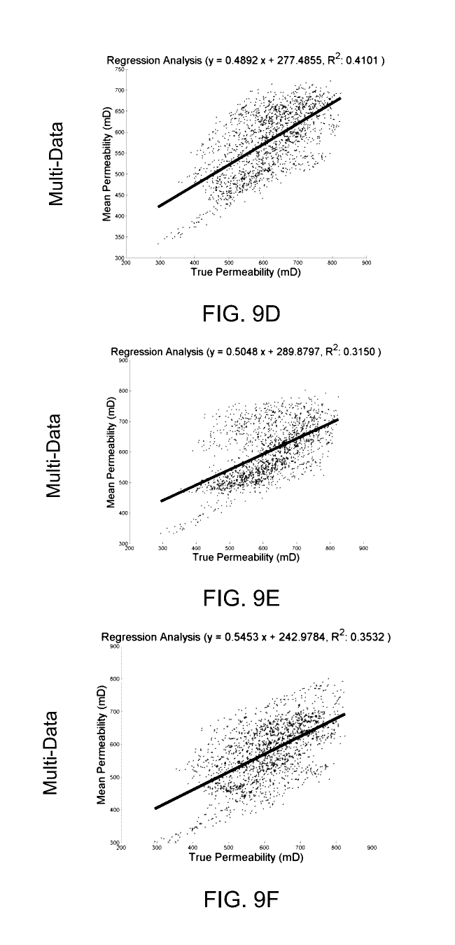

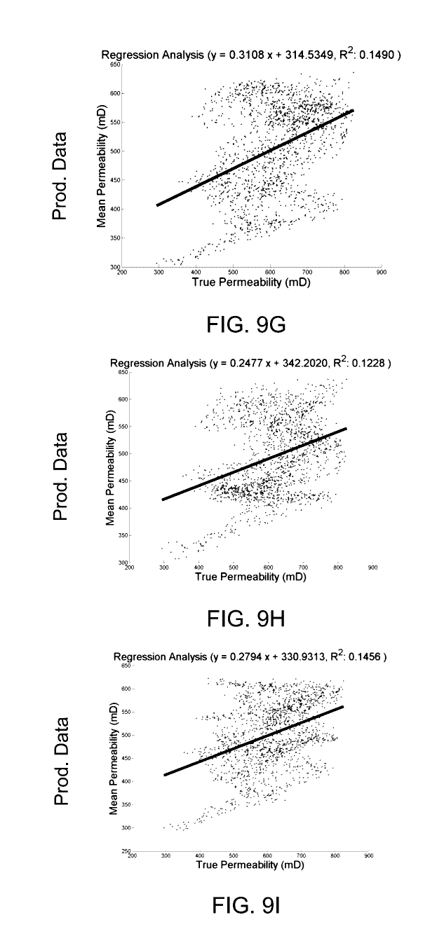

We further study the impact of the ensemble size has on the estimation of the permeability and provide a comparison of the mean permeability estimates as well as a regression analysis in FIGS. 9A-9I. The permeability estimates (FIGS. 9A-9C) verify the earlier drawn conclusion that a multi-data history matching may significantly improve the permeability estimates as compared to history matching incorporating spatially sparse well data. This behavior holds for varying ensemble sizes with the multi-data estimates being significantly better both in visual terms as well as in terms of the regression analysis (FIGS. 9D-9I). Comparing multi-data history matching versus well data matching, the R² values differ by as much as 0.3 points, implying that there is considerable stronger deviation from the true permeabilities for the well data case versus the multi-data estimates. A perfect estimate of the permeability should result into a straight line with R² value being close to 1. An interesting aspect observable in FIGS. 9A-9I is that an increasing ensemble size yields no improvement for the multi-data history matching case, while it sharpens the permeability front and for larger ensemble sizes yields equivalent matches.

### History Matching Analysis & Observation Impact

We now provide a more comprehensive analysis of the history matching enhancements and the impact each observation has on the matching quality. Table 2 provides an overview of the matching enhancement multi-data history matching achieves as compared to well data history matching. Focusing on the matching improvement as provided in Table 2 the incorporation of multiple data returns RMSE error reductions by as much as 97%, with the minimal enhancement being above 60% illustrating the significant matching enhancement information from multiple data sources may deliver. To gain a more detailed understanding of the reasons for the significant enhancement, we display in Table 3 the self-similarity coefficient as explained before. With higher self-similarity coefficients indicating a stronger impact of the observation on the matching improvement, the representation clearly outline the reason for the significant reduction in the RMSE with EM and Seismic data exhibiting much stronger influence in the matching improvement versus the well data, that underlies the stronger sensitivity of cross-well seismic and electromagnetics techniques on the propagation of fluid fronts as compared to other data. The stronger impact of EM data can be traced back to the fact that the fluid contrasts obtained from EM imaging are stronger as compared to Seismic techniques [50], hence achieve a stronger differentiation that is subsequently exploited in improving the estimates. The impact of gravimetry and InSAR data is substantially less or comparable to contribution of the well data. This agrees with observations that while InSAR and gravimetry techniques are inexpensive, their fluid differentiation ability is rather weak in the considered cases due to low density difference between oil and water.

Having presented a detailed sensitivity analysis for the cases studied above, we outline in Table 4 the changes in sensitivity of the different data for a change in fluid properties.

TABLE 2
Average matching improvements for different production
parameters for five considered scenarios showing the
considerable reductions in the RMSE errors.
Average Matching enhancement (w.r.t PROD %)

| Parameter | T1 | T2 | T3 | T4 | T5 |
|---|---|---|---|---|---|
| Oil prod. (Avg Wells) | 71.86 | 64.42 | 71.20 | 75.70 | 75.71 |
| Water Cut (Avg Wells) | 72.26 | 63.83 | 70.18 | 74.85 | 74.91 |
| Pressure Level | 87.78 | 79.54 | 85.44 | 82.89 | 88.40 |
| Total Field Prod. | 80.37 | 80.71 | 88.74 | 96.86 | 93.32 |
| Total Field Water Cut | 81.28 | 72.49 | 80.26 | 84.09 | 82.88 |

TABLE 3
Observation impact (expressed via the self-similarity coefficient)
for different test cases. The self sensitivity coefficients clearly
exhibit the strong impact the crosswell seismic and electromagnetic
techniques have on the improvement of the history matches.
Observation Impact (SS)

| Case | Prod. | Seismic | EM | GM | InSAR |
|---|---|---|---|---|---|
| 1 | 0.03298 | 0.173644 | 0.916307 | 0.124408 | 0.042869 |
| 2 | 0.036102 | 0.19979 | 0.99034 | 0.0006807 | 0.042769 |
| 3 | 0.02757 | 0.115805 | 0.912616 | 0.0001 | 0.0200734 |
| 4 | 0.0462903 | 0.108623 | 0.912645 | 0.0012 | 0.03898 |
| 5 | 0.0576254 | 0.174368 | 0.959531 | 0.000768 | 0.053622 |

The studied reservoir consists of light hydrocarbons, such as natural gas, with the geological structure and state parameters being the same as for the cases studied above. While the impact of EM as compared to Seismic remains stronger as explained in the previous case, gravimetric data exhibit a much stronger impact due to the stronger density contrast. The enhancement in sensitivity for gravimetric techniques can be deduced from the strong dependence of the density of the formation, where the density changes due to water influx are much stronger than in the previous case. This observation agrees with field studies that have illustrated that gravimetric techniques are extremely useful for low density hydrocarbon reservoirs caused by the strong density contrast [51, 52, 15].

TABLE 4
Observation impact (expressed via the self-similarity coefficient)
for different test cases for low-density hydrocarbon. The self
sensitivity coefficients clearly exhibit the stronger sensitivity
of gravimetric techniques caused by the density contrast
between the hydrocarbon and water.
Observation Impact (SS) - Light Hydrocarbon

| Case | Prod. | Seismic | EM | GM | InSAR |
|---|---|---|---|---|---|
| 1 | 0.0392861 | 0.154301 | 0.577947 | 0.99034 | 0.00921734 |
| 2 | 0.0361785 | 0.142095 | 0.53223 | 0.91202 | 0.00850506 |
| 3 | 0.0438305 | 0.13713 | 0.480533 | 0.948148 | 0.0103907 |
| 4 | 0.0305301 | 0.0709329 | 0.871288 | 0.916944 | 0.0154823 |
| 5 | 0.0383472 | 0.916307 | 0.649739 | 0.877644 | 0.0100161 |

### CONCLUSION

We have, thus, presented a multi-data reservoir history matching framework for the assimilation of EM, Seismic, Gravimetry and InSAR data using an ensemble based history matching scheme. Utilizing time lapse seismic surveys incorporating Biot's theory, we complemented the seismic information with EM surveys to achieve a better differentiation between hydrocarbon and fluid fronts, and incorporated in addition Gravimetry and surface displacement data from InSAR measurements for having a more profound knowledge of the subsurface mass redistribution and pressure changes in the reservoir. The incorporation of multiple data exhibits considerable estimation enhancements for crucial reservoir monitoring parameters such as production output, water cut, bottom hole pressures, being reflected in the more precise subsurface permeability and porosity estimates. The estimation impact of the incorporation of multiple data was analyzed via an adjoint-free sensitivity analysis for the EnKF suggest stronger impact for the crosswell seismic and EM data as compared to the gravimetry and InSAR data. This agrees with the conclusions drawn in the industry showing that crosswell techniques provide higher resolution while being substantially more expensive, while gravimetry and InSAR [50] provide an inexpensive alternative for frequent reservoir monitoring although with less resolution.

Summarizing, the presented exemplary history matching framework provides a comprehensive study on the effects of the incorporation of multiple observational data into an EnKF based framework, and determines the impact each observation has on the estimation enhancement, hence allowing the optimization of monitoring strategies and creation of higher precision return on investment analysis.

Although the reservoir forecasting application, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart of FIG. 1 shows the functionality and operation of an implementation of portions of the reservoir forecasting application. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flowchart of FIG. 1 shows a specific order of execution, it is understood that the order of execution may differ from that which is depicted. For example, the order of execution of two or more blocks may be scrambled relative to the order shown. Also, two or more blocks shown in succession in FIG. 1 may be executed concurrently or with partial concurrence. Further, in some embodiments, one or more of the blocks shown in FIG. 1 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the reservoir forecasting application, that comprises software or code can be embodied in any non-transitory computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the reservoir forecasting application, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device, or in multiple computing devices in the same computing environment 103. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

[1] S. Aanonsen, D. Oliver, A. Reynolds, B. Vallis, The Ensemble Kalman Filter in Reservoir Engineering—a Review, SPE Journal 14 (3) (2009)393-412.
[2] Y. Gu, D. Oliver, History matching of the PUNQ-S3 reservoir model using the ensemble Kalman filter, SPE journal 10 (2) (2005) 217-224.
[3] M. Krymskaya, R. Hanea, M. Verlaan, An iterative ensemble Kalman filter for reservoir engineering applications, Computational Geosciences 13 (2) (2009) 235-244.
[4] 0. Leeuwenburgh, J. Brouwer, M. Trani, Ensemble-based conditioning of reservoir models to seismic data, Computational Geosciences 15 (2) (2011) 359-378.
[5] F. Ravanelli, I. Hoteit, History matching time-lapse crosswell data using the ensemble Kalman filter, Submitted to SPE Journal.
[6] M. Wilt, D. Alumbaugh, H. Morrison, Others, Crosswell electromagnetic tomography: System design considerations and field results, Geophysics 60 (3) (1995) 871-885.
[7] M. Wilt, D. Alumbaugh, Oil field reservoir characterization and monitoring using electromagnetic geophysical techniques, Journal of Petroleum Science and Engineering 39 (1) (2003) 85-97.
[8] K. Katterbauer, I. Hoteit, S. Sun, EMSE: Synergizing EM and Seismic data attributes for enhanced forecasts of reservoirs, Submitted to Journal of Petroleum Science & Engineering.
[9] K. Katterbauer, I. Hoteit, S. Sun, Exploiting hydrocarbon-water resistivity contrasts for reservoir history matching, submitted to Geophysics.
[10] K. Katterbauer, I. Hoteit, S. Sun, Enhanced reservoir forecasting via full wavefield electromagnetic and seismic surveys, Submitted to SPE Journal.
[11] L. Liang, A. Abubakar, T. Habashy, Others, Joint inversion of time-lapse crosswell electromagnetic, seismic, and production data for reservoir monitoring and characterization, in: SEG Technical Program Expanded Abstracts 2012, Society of Exploration Geophysicists, 2012, pp. 1-7.
[12] J. L. Hare, J. F. Ferguson, C. L. V. Aiken, J. L. Brady, The 4-D mi-crogravity method for waterflood surveillance: A model study for the Prudhoe Bay reservoir, Alaska, Geophysics 64 (1) (1999) 78-87.
[13] M. Van Gelderen, R. Haagmans, M. Bilker, Gravity changes and natural gas extraction in Groningen, Geophysical Prospecting 47 (6) (1999) 979-993.
[14] M. Zumberge, G. Sasagawa, H. Alnes, Others, Time-lapse Seafloor Gravity and Height Measurements for Reservoir Monitoring, in: Offshore Technology Conference, 2012.
[15] M. Glegola, P. Ditmar, R. Hanea, Others, Gravimetric Monitoring of Water Influx Into a Gas Reservoir: A Numerical Study Based on the Ensemble Kalman Filter, SPE Journal 17 (1) (2012) 163-176.
[16] M. Glegola, P. Ditmar, R. Hanea, Others, History Matching Time-Lapse Surface-Gravity and Well-Pressure Data With Ensemble Smoother for Estimating Gasfield Aquifer Support—A 3D Numerical Study, SPE Journal 17 (4) (2012) 966-980.
[17] J. Du, G. McColpin, E. Davis, S. Marsic, Model uncertainties and resolution studies with application to subsurface movement of a CO2 injection project in the Krechba Field using InSAR data, Journal of Canadian Petroleum Technology 49 (6) (2010) 31-37.
[18] B. Lecampion, G. Cooksley, M. Loizzo, Others, Inversion of Time-lapse InSAR Data for Reservoir Pressure Monitoring: Example of the Krechba Field, Algeria, in: SPE EUROPEC/EAGE Annual Conference and Exhibition, 2011.
[19] S. del Conte, A. Belson, A. Tamburini, Others, Advanced InSAR Technology for Reservoir Monitoring and Reservoir Geomechanical Model Calibration, in: Second EAGE Workshop on Iraq, 2013.
[20] A. Tamburini, S. Del Conte, A. Ferretti, S. Cespa, A. Rucci, Advanced InSAR Technology for Reservoir Monitoring and Geomechanical Model Calibration, in: 2013 SPE Kuwait Oil and Gas Show and Conference, 2013.
[21] K. Katterbauer, I. Hoteit, S. Sun, On the usage of surface deformation measurements and reservoir gravity anomalies in reservoir history matching, Submitted to Geophysics.
[22] D. Daescu, R. Todling, Adjoint sensitivity of the model forecast to data assimilation system error covariance parameters, Quarterly Journal of the Royal Meteorological Society 136 (653) (2010) 2000-2012.
[23] R. Todling, Comparing Two Approaches for Assessing Observation Impact, Monthly Weather Review 141 (5) (2013) 1484-1505.
[24] J. Liu, E. Kalnay, Estimating observation impact without adjoint model in an ensemble Kalman filter, Quarterly Journal of the Royal Meteorological Society 134 (634) (2008) 1327-1335.
[25] J. Liu, E. Kalnay, T. Miyoshi, C. Cardinali, Analysis sensitivity calculation in an ensemble Kalman filter, Quarterly Journal of the Royal Meteorological Society 135 (644) (2009) 1842-1851.
[26] 0. Leeuwenburgh, EnKF Module for MRST—ISAPP (2013). URL http://www.isapp2.com/data-sharepoint/enkf-module-for-mrst
[27] K. Lie, S. Krogstad, I. Ligaarden, Others, Open-source MATLAB implementation of consistent discretisations on complex grids, Computational Geosciences 16 (2) (2012) 297-322.
[28] Z. Chen, Reservoir Simulation: Mathematical Techniques in Oil Recovery, CBMS-NSF regional conference series in applied mathematics, Society for Industrial and Applied Mathematics (SIAM), 2007.
[29] M. Biot, Mechanics of deformation and acoustic propagation in porous media, Journal of Applied Physics 33 (4) (1962) 1482-1498.
[30] M. Biot, Theory of Propagation of Elastic Waves in a Fluid Saturated Porous Solid. II. Higher Frequency Range, The Journal of the Acoustical Society of America 28 (2).
[31] G. Mavko, T. Mukerji, J. Dvorkin, The rock physics handbook: Tools for seismic analysis of porous media, Cambridge University Press, 2009.
[32] R. Nolen-Hoeksema, Modulus-porosity relations, Gassmann's equations, and the low-frequency elastic-wave response to fluids, Geophysics 65 (5) (2000) 1355-1363.
[33] A. Nalonnil, B. Marion, High-resolution reservoir monitoring using crosswell seismic, SPE Reservoir Evaluation & Engineering 15 (1) (2012) 25-30.
[34] G. Archie, The electrical resistivity log as an aid in determining some reservoir characteristics, Trans. AIMe 146 (99) (1942) 54-62.
[35] A. I. Dresser, Well loggin and interpretation techniques, Tech. rep., Dresser Industries (1982).
[36] J. Flury, R. Rummel, Future satellite gravimetry and earth dynamics, Springer, 2005.
[37] J. Granda, A. Arnaud, Reservoir Monitoring Using Radar Satellites, in: Asia Pacific Oil and Gas Conference & Exhibition, 2009.
[38] A. Tamburini, M. Minini, A. Ferretti, Others, Coupling Time-lapse Monitoring by Satellite Radar Sensors and Numerical Geomechanical Models for Reservoir Management. The Tengiz oil field (Kazakhstan) case study., in: EGU General Assembly Conference Abstracts, Vol. 15, 2013, p. 6226.
[39] W. Pratt, D. Johnson, Local subsidence of the Goose Creek oil field, The Journal of Geology (1926) 577-590.
[40] J. Geertsma, Land subsidence above compacting oil and gas reservoirs, Journal of Petroleum Technology 25 (6) (1973) 734-744.
[41] R. Wang, H. Ku\ddot{}mpel, Poroelasticity: Efficient modeling of strongly coupled, slow deformation processes in a multilayered half-space, Geo-physics 68 (2) (2003) 705-717.
[42] G. Evensen, Sequential data assimilation with a nonlinear quasi-geostrophic model using Monte Carlo methods to forecast error statistics, Journal of Geophysical Research: Oceans (1978-2012) 99 (C5) (1994) 10143-10162.
[43] G. Burgers, P. van Leeuwen, G. Evensen, Analysis scheme in the ensemble Kalman filter, Monthly weather review 126 (6) (1998) 1719-1724.
[44] C. Cardinali, S. Pezzulli, E. Andersson, Influence-matrix diagnostic of a data assimilation system, Quarterly Journal of the Royal Meteorological Society 130 (603) (2004) 2767-2786.
[45] R. Powers, L. Ramirez, C. Redmond, E. Elberg, Geology of the Arabian peninsula, Geological survey professional paper 560 (1966) 1-147.
[46] S. Bakan, A. Chlond, U. Cubasch, Others, Climate response to smoke from the burning oil wells in Kuwait, Nature 351 (6325) (1991) 367-371.
[47] J. Onwunalu, L. Durlofsky, A new well-pattern-optimization procedure for large-scale field development, SPE Journal 16 (3) (2011) 594-607.
[48] A. Marsala, M. Buali, Z. Al-Ali, Others, First Borehole to Surface Electromagnetic Survey in KSA: Reservoir Mapping and Monitoring at a New Scale, in: SPE Annual Technical Conference and Exhibition, 2011.
[49] H. Saito, D. Nobuoka, H. Azuma, Others, Time-lapse crosswell seismic tomography for monitoring injected CO2 in an onshore aquifer, Na-gaoka, Japan, Exploration Geophysics 37 (1) (2006) 30-36.
[50] F. Aminzadeh, S. Dasgupta, Geophysics for Petroleum Engineers, Developments in Petroleum Science, Elsevier Science, 2013.
[51] O. Eiken, T. Stenvold, M. Zumberge, H. v. Alnes, G. Sasagawa, Gravi-metric monitoring of gas production from the Troll field, Geophysics 73 (6) (2008) WA149-WA154.
[52] T. Stenvold, O. Eiken, M. Landro, Gravimetric monitoring of gas-reservoir water influxA combined flow- and gravity-modeling approach, Geophysics 73 (6) (2008) WA123-WA131.

1. A method, comprising:
initializing, in a computing device, a reservoir simulator based at least in part on a geological model;
generating, in the computing device, at least two observational data sets based at least in part on a current reservoir simulator state of the reservoir simulator by querying a corresponding at least two of: a seismic survey module, an electromagnetic (EM) survey module, a gravimetric survey module, or an interferometric synthetic aperture radar (InSAR) survey module;
generating, in the computing device, a forecasted reservoir simulator state by applying a history matching approach to at least the current reservoir simulator state and the at least two observational data sets; and
updating, in the computing device, the current reservoir simulator state to the forecasted reservoir simulator state.

2. The method of claim 1, wherein generating the at least two observational data sets, generating the forecasted reservoir simulator state, and updating the current reservoir simulator state are repeated until a termination criteria is met.

3. The method of claim 1, wherein the reservoir simulator is implemented using a MATLAB reservoir simulator toolbox.

4. The method of claim 1, wherein the history matching approach comprises a Bayesian data assimilation technique.

5. The method of claim 4, wherein the Bayesian data assimilation technique comprises an Ensemble Kalman Filter or a singular evolutive interpolated Kalman Filter.

6. The method of claim 1, wherein the at least two observational data sets are included in a plurality of observational data sets based at least in part on each of the seismic survey module, the EM survey module, the gravimetric survey module, or the InSAR survey module, and the history matching approach is applied to the plurality of observational data sets.

7. The method of claim 1, wherein the geological model defines at least one of a geological structure, a number of wells, a pressure, a saturation, a permeability, or a porosity.

8. The method of claim 1, wherein the seismic survey module is configured to calculate a time lapse seismic impedance profile based at least in part on a saturation data, a porosity data and the geological model, and wherein one of the at least two observational data sets comprises the time lapse seismic impedance profile.

9. The method of claim 1, wherein the EM survey module is configured to calculate a time lapse conductivity response based at least in part on a porosity data and a salt concentration data, and wherein one of the at least two observational data sets comprises the time lapse conductivity response.

10. The method of claim 1, wherein the gravimetric survey module is configured to calculate a time lapse gravimetric response based at least in part on a porosity data, a saturation data and the geological model, and wherein one of the at least two observational data sets comprises the time lapse gravimetric response.

11. A system, comprising:
at least one computing device comprising a processor and a memory, configured to at least:
initialize a reservoir simulator based at least in part on a geological model;
generate at least two observational data sets based at least in part on a current reservoir simulator state of the reservoir simulator by querying a corresponding at least two of: a seismic survey module, an electromagnetic (EM) survey module, a gravimetric survey module, or an interferometric synthetic aperture radar (InSAR) survey module;
generate a forecasted reservoir simulator state by applying a history matching approach to at least the current reservoir simulator state and the at least two observational data sets; and
update the current reservoir simulator state to the forecasted reservoir simulator state.

12. The system of claim 11, wherein the at least one computing device is configured to repeat the generating the at least two observational data sets, the generating the forecasted reservoir simulator state, and the updating the current reservoir simulator state until a termination criteria is met.

13. The system of claim 11, wherein the reservoir simulator is implemented using a MATLAB reservoir simulator toolbox.

14. The system of claim 11, wherein the history matching approach comprises a Bayesian data assimilation technique.

15. The system of claim 14, wherein the Bayesian data assimilation technique comprises an Ensemble Kalman Filter or a singular evolutive interpolated Kalman Filter.

16. The system of claim 11, wherein the at least two observational data sets are included in a plurality of observational data sets based at least in part on each of the seismic survey module, the EM survey module, the gravimetric survey module, or the InSAR survey module, and the history matching approach is applied to the plurality of observational data sets.

17. The system of claim 11, wherein the geological model defines at least one of a geological structure, a number of wells, a pressure, a saturation, a permeability, or a porosity.

18. The system of claim 11, wherein the seismic survey module is configured to calculate a time lapse seismic impedance profile based at least in part on a saturation data, a porosity data and the geological model, and wherein one of the at least two observational data sets comprises the time lapse seismic impedance profile.

19. The system of claim 11, wherein the EM survey module is configured to calculate a time lapse conductivity response based at least in part on a porosity data and a salt concentration data, and wherein one of the at least two observational data sets comprises the time lapse conductivity response.

20. The system of claim 11, wherein the gravimetric survey module is configured to calculate a time lapse gravimetric response based at least in part on a porosity data, a saturation data and the geological model, and wherein one of the at least two observational data sets comprises the time lapse gravimetric response.
